(19) United States
(12) Patent Application Publication
(10) Pub. No.: US 2025/0369262 A1
(43) Pub. Date: Dec. 4, 2025

(54) FAIL SAFE LATCH SYSTEM

(71) Applicant: Rivian IP Holdings, LLC, Irvine, CA (US)

(72) Inventors: Srinivasa Sastry GUNTUR, Charlotte, NC (US); Gerard JOYCE, Mountain View, CA (US)

(21) Appl. No.: 19/182,417

(22) Filed: Apr. 17, 2025

Related U.S. Application Data
(60) Provisional application No. 63/652,603, filed on May 28, 2024.

(51) Int. Cl. E05B 77/54; B60W 10/04; B62D 25/10; E05B 83/24

(52) U.S. Cl. CPC E05B 77/54; B60W 10/04; B62D 25/105; E05B 83/24

(57) ABSTRACT

A system includes multiple controllers that provide operation of a closure with multi-layer functionality and redundancy. One controller monitors a state of a latch coupled with the closure, while another controller controls a motor used to actuate the latch. When the controller monitoring the state of the latch detects a fault, the controller communicates the fault to the other controller and the other controller disables the motor, thus preventing further movement of the latch, and in turn, the closure.

### CROSS REFERENCE TO RELATED APPLICATION(S)

The present application claims the benefit of U.S. Provisional Application No. 63/652,603, entitled “FAIL SAFE LATCH SYSTEM”, filed May 28, 2024, the entirety of which is incorporated herein for reference.

### INTRODUCTION

This application is directed to vehicles, and more particularly, to vehicles with a system to monitor for and prevent unwanted movement of a closure (e.g., hood).

### SUMMARY

Aspects of the present disclosure are directed to using multiple controllers to provide a multi-layer, redundant system for operating a closure. The multiple controllers may provide a fail safe system to safely manage the closure, thus providing a potential higher industry safety rating.

In accordance with one or more aspects of the present disclosure, a system is described. The system may include a first controller configured to monitor a state of a latch. The system may further include a second controller in communication with the first controller and configured to control a motor that actuates the latch. In response to a fault detected by the first controller, the second controller may disable the motor to prevent a change of the state of the latch.

The first controller may be further configured to limit a speed of a vehicle in response to the fault being detected. The second controller may be further configured to disable the motor in response to a speed of a vehicle exceeding a threshold speed. The first controller may be further configured to provide a command to change the state of the latch from a first state to a second state different from the first state. The first state may include an open state, and the second state may include a closed state. In response to the first controller detecting a change of the state of the latch from the first state to the second state, the second controller may be configured to disable the motor. The first controller may be further configured control a position of closure based on the latch and the motor. The first controller and the second controller may be further configured override a command to operate a closure coupled with the latch in response to detection of the fault by the first controller.

In accordance with one or more aspects of the present disclosure, a method is described. The method may include monitoring, by a first controller, a state of a latch. The method may further include in response to a fault detected by the first controller: providing, by the first controller to a second controller, data indicating the fault; and disabling, by the second controller, a motor configured to change the state of the latch.

In response to the fault being detected by the first controller, providing, by the first controller, a command to limit a speed of a vehicle. In response to a speed of a vehicle exceeding a threshold speed, disabling, by the second controller, the motor.

The method may further include providing, by the first controller, a command to change the state of the latch from a first state to a second state different from the first state. The method may further include disabling, by the second controller based on the change to the second state, the motor. The method may further include determining, by the first controller, the state of the latch transitioned from a first state to a second state different from the first state. The method may further include disabling, by the second controller based on the transition to the second state, the motor.

The method may further include receiving, by the first controller, an indication a speed of a vehicle exceeds a threshold speed. The method may further include disabling, by the second controller, the motor based on the speed exceeding the threshold speed. The method may further include controlling, by the first controller, a position of a closure coupled with the latch. The method may further include controlling, by the second controller, the position of the closure based on a command to the motor.

In accordance with one or more aspects of the present disclosure, a vehicle is described. The vehicle may include a closure configured to cover an internal space of a vehicle body. The vehicle may further include a latch coupled to the closure. The closure may be movable based on the latch. The vehicle may further include a motor configured to actuate the latch to move the closure. The vehicle may further include a first controller configured to monitor a state of the latch. The vehicle may further include a second controller in communication with the first controller and configured to control the motor. In response to a fault detected by the first controller, the second controller may disable the motor to prevent a change of the state of the latch.

The vehicle may further include one or more drive units. The first controller may be further configured to control the one or more drive units to limit a speed of the vehicle in response to the fault being detected. The second controller may be further configured to disable the motor in response to a speed of the vehicle exceeding a threshold speed. The first controller and the second controller may be further configured override a command to operate the closure in response to detection of the fault by the first controller.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with one or more aspects of the present disclosure.

FIG. 2 illustrates a side view of an alternate embodiment of a vehicle, in accordance with one or more aspects of the present disclosure.

FIG. 3 illustrates an enlarged side view of an embodiment of a vehicle, showing various positions of a closure of a vehicle, in accordance with one or more aspects of the present disclosure.

FIG. 4A, FIG. 4B, and FIG. 4C illustrate example positions of a closure based on respective positions of a latch, in accordance with one or more aspects of the present disclosure.

FIG. 5 illustrates a block diagram of a vehicle, in accordance with one or more aspects of the present disclosure.

FIG. 6 illustrates a block diagram of the controllers shown in FIG. 5, showing additional functions of the controllers, in accordance with one or more aspects of the present disclosure.

FIG. 7 illustrates a flow diagram showing an example of a process that may be performed for operating a closure of a vehicle, in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to monitoring and limiting or preventing a latch from unintentional movement, particularly during relatively high speeds of a vehicle. The latch described herein may be used to operate a closure. In one or more implementation, the closure takes the form of a hood designed to cover an internal space (e.g., frunk) of the vehicle. By limiting/preventing movement of the latch, a corresponding movement of the closure may also be limited/prevented. Systems described herein may include a controller (e.g., first controller) designed to operate the latch, thus controlling the position the closure. Additionally, the controller may monitor a state (e.g., closed state, partially open state/partially closed state, closed state) of the latch to provide an indication of the position of the closure. The latch may be actuated, or moved, by a motor, and the controller may provide commands to the motor. When monitoring the state of the latch, the controller may detect a fault corresponding to an unintended, unexpected, or undesirable state of the latch, which may lead to an undesirable position of the closure. In this regard, the systems described herein may further include an additional controller (e.g., second controller) designed to control the motor by, for example, disabling the motor when the first controller detects the fault. As an example, when a fault is detected by the first controller (corresponding to an unexpected position of the latch), the second controller may disable the motor controlling the latch by cutting power to the motor. As a result, the closure may be partially open, but not further open. As a result, the closure may not further move and block a field of view of a driver of the vehicle. Beneficially, systems described herein may provide a multi-layer system in the form of multiple controllers operating an automated latch to ensure safety while operating a vehicle.

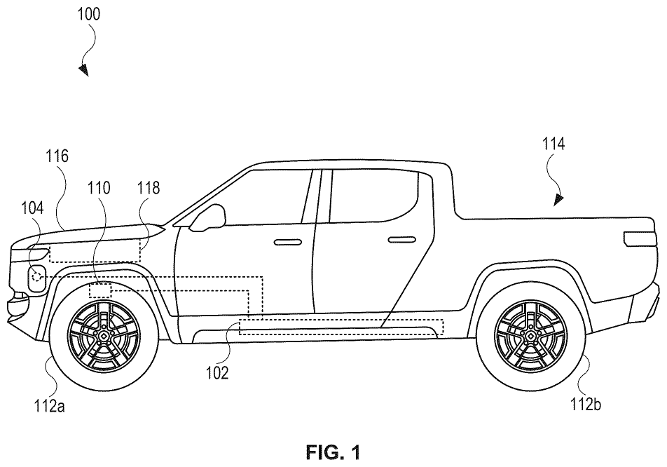

FIG. 1 illustrates an example of a vehicle 100, in accordance with aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, at least some implementations of the vehicle 100 may include land-based vehicles, such as a car (e.g., sedan, hatchback), a van, or a commercial truck, as non-limiting examples.

The vehicle 100 may include a battery pack 102. The battery pack 102 may be coupled (e.g., electrically coupled) to one or more electrical systems of the vehicle 100 to provide power to the one or more electrical systems. The vehicle 100 may further include a port 104 (e.g., charge port) designed to receive a cable connector (not shown in FIG. 1) used to transmit power (e.g., alternating current (AC) power) that is converted to direct current (DC) power to charge the battery pack 102. The battery pack 102 may couple to a drive unit 110, representative of one or more drive units of the vehicle 100. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100. The vehicle 100 may further include a bed 114 that may be used as a storage area for the vehicle 100.

Additionally, the vehicle 100 may include a closure 116. In one or more implementations, the closure 116 takes the form of a hood. In this regard, the vehicle 100 may further include an internal space 118 (e.g., front trunk, frunk) that provides a storage area. The closure 116 is designed to move (e.g., rotate) to provide access to the internal space 118.

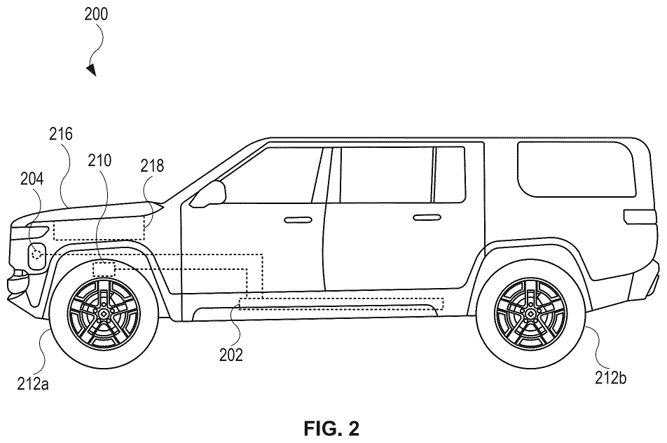

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a battery pack 202, a port 204 (e.g., charge port), a drive unit 210 (representative of one or more additional drive units), a wheel 212a (representative of an additional front wheel), a wheel 212b (representative of an additional rear wheel), a closure 216, and an internal space 218.

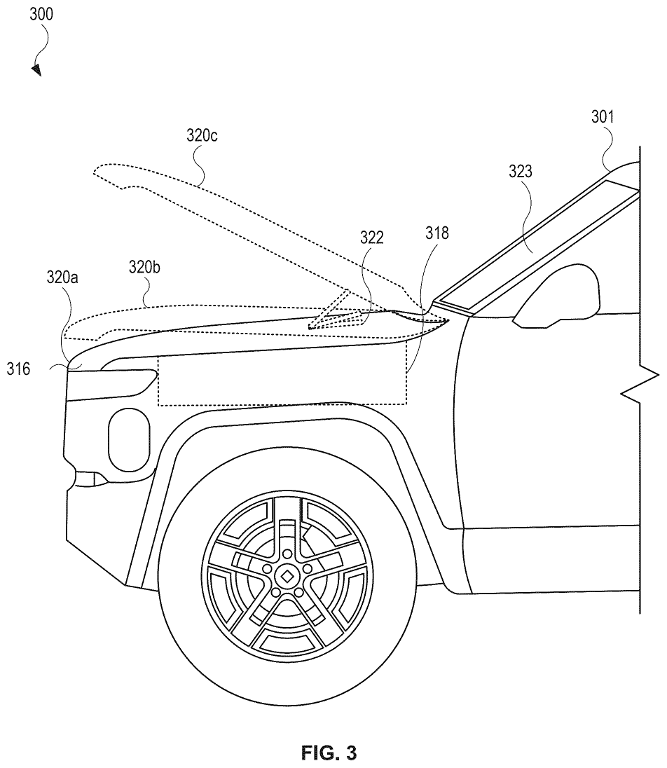

FIG. 3 illustrates an enlarged side view of an embodiment of a vehicle 300, showing various positions of a closure 316 of the vehicle 300, in accordance with one or more aspects of the present disclosure. The vehicle 300 may take the form of a truck (e.g., vehicle 100 shown in FIG. 1) or an SUV (e.g., vehicle 200 shown in FIG. 2). The vehicle 300 may include a vehicle body 301 and the closure 316 may be coupled (e.g., rotationally coupled) with the vehicle body 301.

The vehicle 300 may further include a latch 322 (representative of an additional latch). The closure 316 may be movable to different positions based on the latch 322. For example, the closure 316 may be in a position 320a representing a closed position in which an internal space 318 of the vehicle 300 is covered (e.g., fully covered) by the closure 316. Additionally, the closure 316 may transition to a position 320b representing a partially open (or partially closed) position in which the internal space 318 is at least partially uncovered by the closure 316. Further, the closure 316 may transition to a position 320c representing an open (e.g., fully open) position in which the internal space 318 is accessible (e.g., fully accessible) to a user. The latch 322 may be used to move the closure 316 to each of the positions 320a, 320b, and 320c.

In the position 320c, the closure 316 may be positioned between a windshield 323 of the vehicle 300 and the environment (e.g., road, terrain) in front of the vehicle 300. In this regard, the vision of a driver (not shown in FIG. 3) in the vehicle 300 may be impeded by the closure 316, thus creating a safety hazard. This may occur based on an unintended opening of the closure 316. However, the closure 316 may be monitored and managed to prevent this issue.

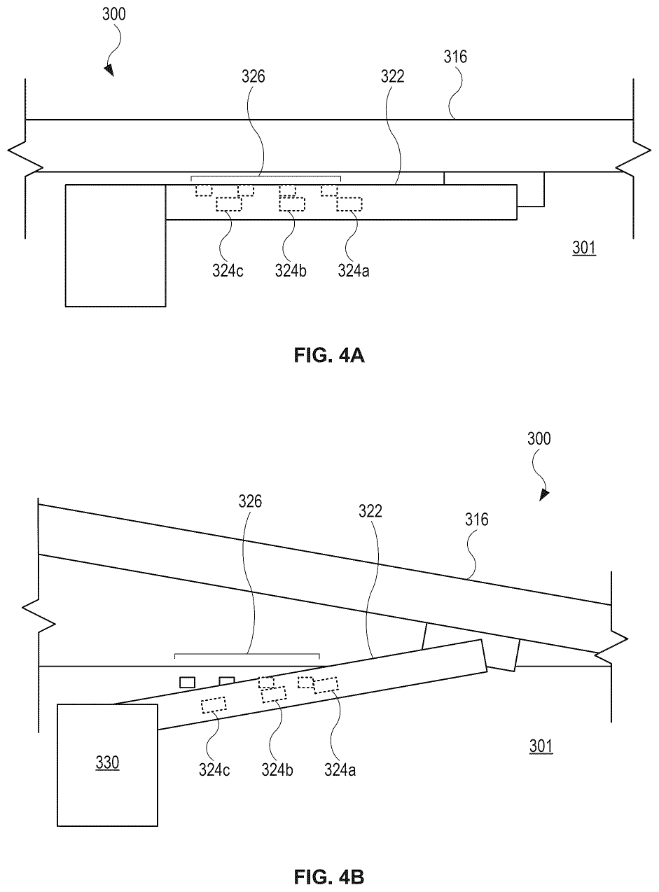

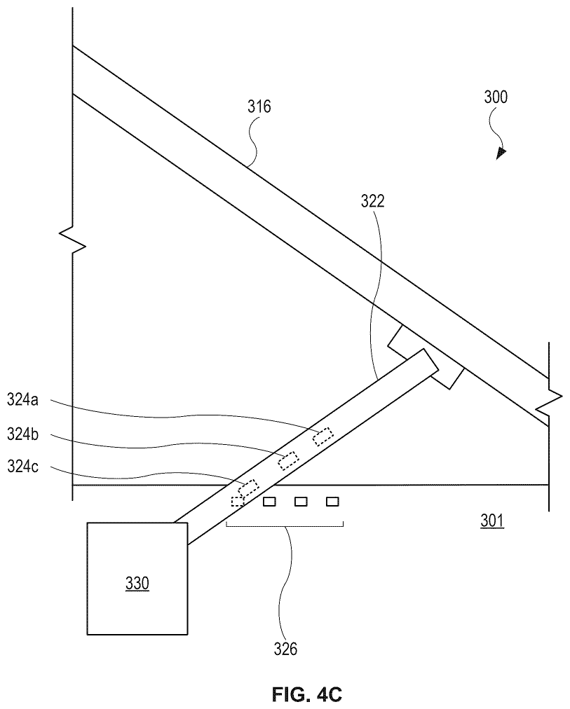

FIG. 4A, FIG. 4B, and FIG. 4C illustrate example positions of the closure 316 based on respective positions of the latch 322, in accordance with one or more aspects of the present disclosure. Referring to FIG. 4A, the latch 322 is in a closed position, corresponding to the position 320a of the closure 316 shown in FIG. 3. The vehicle 300 may include several sensors. For example, the vehicle 300 may include a sensor 324a, a sensor 324b, and a sensor 324c. As shown, each of the sensors 324a, 324b, and 324c is coupled with the latch 322, and each of the sensors 324a, 324b, and 324c moves when the latch 322 moves. In one or more implementations, each of the sensors 324a, 324b, and 324c takes the form a magnetic field sensor, such as a Hall Effect sensor (as a non-limiting example), designed to detect a magnetic field generated by a magnet or magnets.

The vehicle 300 may further include magnets 326 (shown as dotted lines). The magnets 326 may be coupled to the vehicle body 301. The magnets 326 represent an array of magnets in which the respective magnetic fields of the magnets 326 may be measured by one or more of the sensors 324a, 324b, and 324c, based upon the relative position of the sensors 324a, 324b, and 324c with respect to the magnets 326. Additionally, the polarity (e.g., magnetic polarity) of the magnets 326 may be differ such that some of the magnets 326 provide magnetic flux measurable in one direction corresponding to North pole, while other of the magnets 326 provide magnetic flux measurable in another direction corresponding to South pole. In this regard, based on detection of the respective magnetic fields of the magnets 326, the collective output of the sensors 324a, 324b, and 324c may create a signature (e.g., a particular pulse or pulses of electrical current) and provide an output corresponding to a position of the latch 322. The vehicle 300 may use the signature to determine the latch 322 and the closure 316 are in the position (e.g., closed position).

Referring to FIG. 4B, the latch 322 transitions from the closed position to a partially open (or partially closed) position, corresponding to the position 320b of the closure 316 shown in FIG. 3. The vehicle 300 may include a motor 330 used to provide work (e.g., torque) to drive (e.g., move) the latch 322, thus altering a position of the closure 316. Based on the movement of the latch 322, each of the sensors 324a, 324b, and 324c move relative to the magnets 326. In this regard, one or more of the sensors 324a, 324b, and 324c may measure a magnetic field from at least one of the magnet 326. The measured magnetic fields from the magnets 326 by the sensors 324a, 324b, and 324c differ from those measured in the closed position shown in FIG. 4A. This may include one or more of the sensors 324a, 324b, and 324c no longer measuring a magnetic field from the magnets 326. As a result, the collective output of the sensors 324a, 324b, and 324c creates a different signature corresponding to a position of the latch 322 and the closure 316 shown in FIG. 4B. Accordingly, the vehicle 300 may use the new signature to determine the latch 322 and the closure 316 are in the partially open position.

Referring to FIG. 4C, the latch 322 transitions from the partially open position to an open position, corresponding to the position 320c of the closure 316 shown in FIG. 3. The motor 330 may provide additional work to drive the latch 322 and further alter the position of the closure 316. Based on the movement of the latch 322, each of the sensors 324a, 324b, and 324c again moves relative to the magnets 326. The measured magnetic fields from the magnets 326 by the sensors 324a, 324b, and 324c differ from those measured in the partially open position shown in FIG. 4B and differ from those measured in the closed position shown in FIG. 4A. This may include one or more of the sensors 324a, 324b, and 324c no longer measuring a magnetic field from the magnets 326. As a result, the collective output of the sensors 324a, 324b, and 324c creates yet another different signature corresponding to a position of the latch 322 and the closure 316 shown in FIG. 4C. Accordingly, the vehicle 300 may use the new signature to determine the latch 322 and the closure 316 are in the open position (e.g., fully open position).

Based on the position of the latch 322 in FIGS. 4A, 4B, and 4C, each of the outputs from the sensors 324a, 324b, and 324c provides an indication of the position of the latch 322 and in turn the position of the closure 316. Accordingly, the vehicle 300 may determine, using the respective outputs from the sensors 324a, 324b, and 324c, whether the closure 316 is in a closed state, a partially open state, or an open state. This will be discussed in further detail below. Also, while the sensors 324a, 324b, and 324c are shown as coupled with (e.g., mounted to) the latch 322 and moving relative to the magnets 326 coupled with the vehicle body 301, alternatively the magnets may be coupled with the latch 322 and the sensors 324a, 324b, and 324c may be coupled with the vehicle body 301 such that movement of the latch 322 causes the magnets 326 to move relative to the sensors 324a, 324b, and 324c. Additionally, the number of the sensors 324a, 324b, 324c and the number of the magnets 326 shown in FIGS. 4A-4C may be exemplary and is not intended to be limiting.

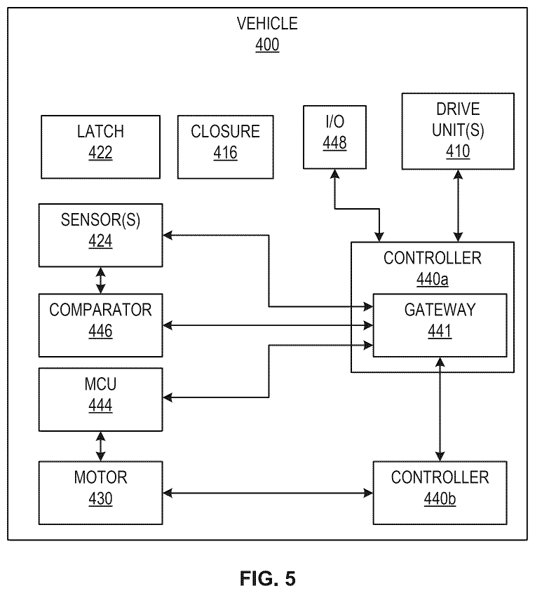

FIG. 5 illustrates a block diagram of a vehicle 400, in accordance with one or more aspects of the present disclosure. The features of the vehicle 400 shown and/or described may be implemented in vehicles previously shown and/or described. As shown, the vehicle 400 includes a controller 440a and a controller 440b designed to receive inputs (e.g., electrical signals) from various components shown and/or described herein, and well as provide outputs or commands (e.g., electrical signals) to components shown and/or described herein. Also, the controller 440a may include a gateway 441 used to communicate with various components shown and/or described herein. Also, at least some of the communication between the controllers 440a and 440b and components may occur through a dedicated input/output channel so as to reduce communication time and enhance safety.

The vehicle 400 may further include a closure 416 and a latch 422. The closure 416 and the latch 422 may function similar to the closure 316 and the latch 322 (shown in FIGS. 3-4C), respectively. The vehicle 400 may further include a motor control unit 444 (MCU). The vehicle 400 may further include a motor 430 that provides work to drive the latch 422, thus moving the closure 416 to a desired position (e.g., shown in FIGS. 3-4C).

As shown, the controller 440a is in communication (e.g., electrical communication) with the motor control unit 444 and the controller 440b is in communication with the motor 430. Additionally, the controllers 440a and 440b are in communication with each other. As a result, the controller 440a and the controller 440a may operate the motor control unit 444 and the motor 430, respectively. Further, the motor control unit 444 and the motor 430 are in communication with each other, and based on the commands, or instructions, received by the controller 440a, the motor control unit 444 may provide commands to operate the motor 430. This may include controlling the motor 430 to output work, thus driving the latch 422 and ultimately placing the closure 416 of the vehicle 400 in a desired position.

In order to monitor a state (e.g., closed, partially open, open) of the latch 422, and in turn, a state of the closure 416, the vehicle 400 may further include one or more sensors 424, each of which may function in a manner similar to that of the sensors 324a, 324b, and 324c (shown in FIG. 4A). Accordingly, the one or more sensors 424 may measure a respective magnetic field from magnets (similar to magnets 326 shown in FIG. 4A) of the vehicle 400, and output a signature corresponding to the measured magnetic fields. The comparator 446 may receive and compare outputted signature with an expected signature. For example, each position of the latch 422 is expected to cause the one or more sensors 424 to provide an expected output (e.g., expected signature). By comparing the outputted signature (based on measured magnetic fields) of the one or more sensors 424 with an expected signature, the comparator 446 may determine whether the latch 422 is in a proper position and thus whether the closure 416 in a desired position. When the comparator 446 determines the outputted signature is within a threshold difference of the expected signature, the comparator 446 may provide data to the controller 440a indicating the latch 422 and the closure 416 are properly positioned. Thus, in addition to providing commands to drive the latch 422 and move the closure 416, the controller 440a may monitor the state of the latch 422.

Conversely, when the comparator 446 determines the outputted signature is not within (e.g., outside of) a threshold difference of the expected signature, the comparator 446 may provide data to the controller 440a indicating the latch 422 is not properly positioned. When the comparator 446 determines the outputted signature is not within the threshold difference of the expected signature, the controller 440a may detect a fault. Subsequently, based on the detected fault, the controller 440a may communicate data to the controller 440b indicating the outputted signature is not within the threshold difference (e.g., indicative of the fault), and the controller 440b may provide a command to the motor 430 to disable the motor 430. As a result, the latch 422, and in turn the closure 416, remain in their fixed positions, even in instances when the controller 440a provides a command to the motor control unit 444 to move the latch 422.

In some instances, the controller 440a may expect the position of the closure 416 to be in a closed position (e.g., shown in FIG. 4A). However, based on the detected fault, the closure 416 may be in the partially open position (e.g., shown in FIG. 4B). Based on the controller 440b disabling the motor 430, the closure 416 is effectively incapable of moving to the open position (e.g., shown in FIG. 4C). Beneficially, the use of multiple controllers (e.g., the controllers 440a and 440b) may provide a multi-layer system with redundancy for operating components (e.g., the motor 430) used to position the closure 416.

Also, the vehicle 400 may further include one or more drive units 410. The one or more drive units 410 may take the form of motors (e.g., electrical motors) designed to provide propulsion to move the vehicle 400. The vehicle 400 may further include one or more input/output devices 448. As non-limiting examples, the one or more input/output devices 448 may include a pedal actuated by a user to increase the speed of the vehicle 400, a braking system actuated by a user to reduce the speed of the vehicle 400, a display capable of receiving touch inputs or gestures, one or more tunable knobs, or a combination thereof. Users of the vehicle 400 may use the display or the tunable knobs to control the position of the closure 416 by providing a command to the display or adjusting the tunable knobs, respectively, each of which may be used to actuate the latch 422 by means previously described.

In one or more implementations, when the controller 440a detects a fault related to the latch 422, the controller 440a may limit the speed of the vehicle 400 to a predetermined speed (e.g., 40 miles per hour), which may be determined as a relatively safe speed. Further, the controller 440b may disable the motor 430 in the event of a fault. In this regard, if the closure 416 is in a partially open position based on the latch 422 and the expected position is a closed position, the vehicle 400 may be operated relatively safely based on the reduced speed. Moreover, the controller 440a and the controller 440b may override the one or more input/output devices 448 by not responding to further actuation of the pedal, thus preventing the one or more drive units 410 from increasing the speed of the vehicle 400 above the threshold speed. Accordingly, the speed of the vehicle 400 may be limited. Additionally, the controller 440a and the controller 440b may override the one or more input/output devices 448 by not responding to an input or gesture to the display or an adjustment to the tunable knobs, thus preventing movement the latch 422 and the closure 416. In yet another example, when the vehicle 400 exceeds the threshold speed, the controller 440a may provide data to the controller 440b indicating the current speed of the vehicle 400 exceeds the threshold speed. Based on the current speed of the vehicle 400 exceeding the threshold speed, the controller 440b may disable the motor 430 thus preventing movement of the latch 422 and the closure 416, despite any command(s) received from the one or more input/output devices 448 to move the closure 416.

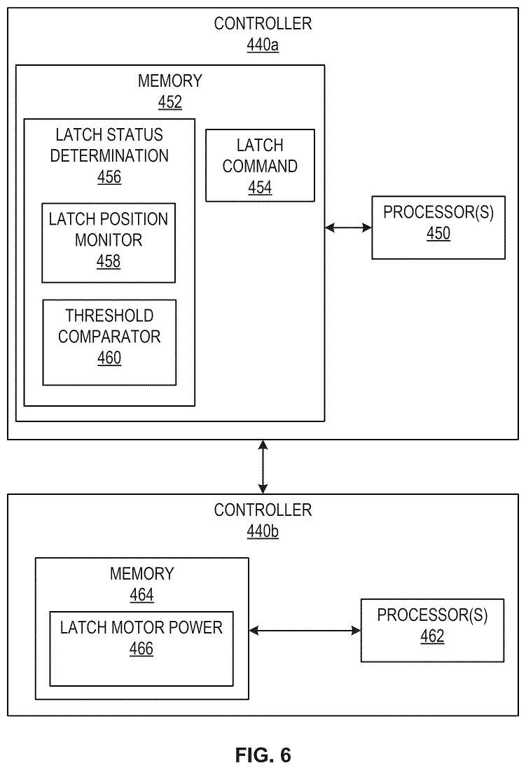

FIG. 6 illustrates a block diagram of the controllers 440a and 440b shown in FIG. 5, showing additional functions of the controllers 440a and 440b, in accordance with one or more aspects of the present disclosure. As shown, the controller 440a may include one or more processors 450 and memory 452. The one or more processors 450 may include one or more microcontrollers, micro-electromechanical system (MEMS) controllers, and/or application-specific integrated circuits. The memory 452 may include a combination of read-only memory and random access memory. The one or more processors 450 may execute instructions stored on the memory 452, including computer-readable media such as non-transitory computer-readable media.

The memory 452 may store several blocks (e.g., software-based blocks) of executable instructions used with at least some components shown in FIG. 5. For example, the memory 452 includes a latch command 454 designed to process commands received at the controller 440a from the one or more input/output devices 448 (shown in FIG. 5) and generate commands to the motor control unit 444 (shown in FIG. 5). The memory 452 may further include a latch status determination 456 designed to monitor a state of the latch 422 (shown in FIG. 5). The latch status determination 456 may include a latch position monitor 458 designed to determine a position of the latch 422 based on data received from the one or more sensor 424 (shown in FIG. 5). The latch status determination 456 may include a threshold comparator 460 designed to use the data from the comparator 446 (shown in FIG. 5) to determine whether the received data from the comparator 446 indicates the outputted signature from the one or more sensors 424 (based on the measured magnetic fields) is within a threshold different from the expected signature. Using the latch status determination 456, the controller 440a may monitor a state of the latch 422 including detecting a fault corresponding to an unintended position of the latch 422 and the closure 416 (shown in FIG. 5).

The controller 440b may include one or more processors 462 and memory 464. The one or more processors 462 and the memory 464 may include any features shown and/or described for the one or more processors 450 and the memory 452, respectively. The memory 464 may store several blocks (e.g., software-based blocks) of executable instructions used with at least some components shown in FIG. 5. For example, the memory 464 includes a latch motor power 466 designed to process commands received at the controller 440b from the controller 440a (e.g., from the latch status determination 456) and generate commands to the motor 430 (shown in FIG. 5). The commands from the controller 440a may cause the controller 440b generate a command to disable the motor 430.

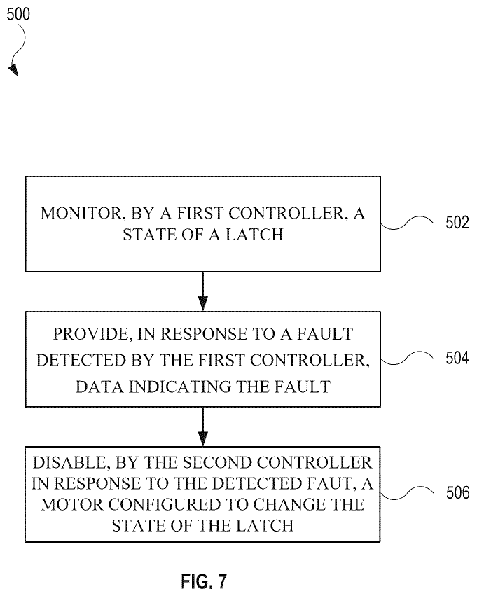

FIG. 7 illustrates a flow diagram showing an example of a process 500 that may be performed for operating a closure of a vehicle, in accordance with one or more implementations of the present disclosure. For explanatory purposes, the process 500 is primarily described herein with reference to closures shown in FIGS. 3-5. However, the process are not limited to the closures shown in FIGS. 3-5, and one or more blocks (or operations) of the process may be performed by one or more other components of other suitable moveable apparatuses, devices, or systems. Further for explanatory purposes, some of the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, a first controller monitors a state of a latch. The first controller (e.g., controller 440a shown in FIGS. 5 and 6) may monitor the state of the latch (e.g., latch 422 shown in FIG. 5) to determine whether the latch is in a closed state, a partially open state, or an open state. The first controller may rely on hardware (e.g., the one or more sensors 424 and the comparator 446 shown in FIG. 5) and software (e.g., latch status determination 456 shown in FIG. 6) to determine the state of the latch.

At block 504, in response to a fault detected by the first controller, the first controller provides data indicating the fault to a second controller (e.g., controller 440b).

At block 506, the second controller, in response to the detected fault, disables a motor (e.g., motor 430 shown in FIG. 5) configured to change the state of the latch. As a result of disabling the motor, the latch is in a fixed position, thereby fixing the position of the closure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system, comprising:
a first controller configured to monitor a state of a latch; and
a second controller in communication with the first controller and configured to control a motor that actuates the latch, wherein in response to a fault detected by the first controller, the second controller disables the motor to prevent a change of the state of the latch.

2. The system of claim 1, wherein the first controller is further configured to limit a speed of a vehicle in response to the fault being detected.

3. The system of claim 1, wherein the second controller is further configured to disable the motor in response to a speed of a vehicle exceeding a threshold speed.

4. The system of claim 1, wherein the first controller is further configured to provide a command to change the state of the latch from a first state to a second state different from the first state.

5. The system of claim 4, wherein:
the first state comprises an open state, and
the second state comprises a closed state.

6. The system of claim 4, wherein in response to the first controller detecting a change of the state of the latch from the first state to the second state, the second controller is configured to disable the motor.

7. The system of claim 1, wherein the first controller is further configured control a position of closure based on the latch and the motor.

8. The system of claim 1, wherein the first controller and the second controller are further configured override a command to operate a closure coupled with the latch in response to detection of the fault by the first controller.

9. A method, comprising:
monitoring, by a first controller, a state of a latch; and
in response to a fault detected by the first controller:
providing, by the first controller to a second controller, data indicating the fault; and
disabling, by the second controller, a motor configured to change the state of the latch.

10. The method of claim 9, wherein in response to the fault being detected by the first controller, providing, by the first controller, a command to limit a speed of a vehicle.

11. The method of claim 9, wherein in response to a speed of a vehicle exceeding a threshold speed, disabling, by the second controller, the motor.

12. The method of claim 9, further comprising:
providing, by the first controller, a command to change the state of the latch from a first state to a second state different from the first state; and
disabling, by the second controller based on the change to the second state, the motor.

13. The method of claim 9, further comprising:
determining, by the first controller, the state of the latch transitioned from a first state to a second state different from the first state; and
disabling, by the second controller based on the transition to the second state, the motor.

14. The method of claim 9, further comprising:
receiving, by the first controller, an indication a speed of a vehicle exceeds a threshold speed; and
disabling, by the second controller, the motor based on the speed exceeding the threshold speed.

15. The method of claim 9, further comprising controlling, by the first controller, a position of a closure coupled with the latch.

16. The method of claim 15, controlling, by the second controller, the position of the closure based on a command to the motor.

17. A vehicle, comprising:
a closure configured to cover an internal space of a vehicle body;
a latch coupled to the closure, wherein the closure is movable based on the latch;
a motor configured to actuate the latch to move the closure;
a first controller configured to monitor a state of the latch; and
a second controller in communication with the first controller and configured to control the motor, wherein in response to a fault detected by the first controller, the second controller disables the motor to prevent a change of the state of the latch.

18. The vehicle of claim 17, further comprising one or more drive units, wherein the first controller is further configured to control the one or more drive units to limit a speed of the vehicle in response to the fault being detected.

19. The vehicle of claim 17, wherein the second controller is further configured to disable the motor in response to a speed of the vehicle exceeding a threshold speed.

20. The vehicle of claim 17, wherein the first controller and the second controller are further configured override a command to operate the closure in response to detection of the fault by the first controller.
